(19) United States
(12) Patent Application Publication
(10) Pub. No.: US 2017/0018224 A1
(43) Pub. Date: Jan. 19, 2017

(54) APPARATUS AND METHOD FOR COMPENSATING FOR LUMINANCE DIFFERENCE OF ORGANIC LIGHT-EMITTING DISPLAY DEVICE

(71) Applicant: NEOVIEW KOLON CO., LTD., Hongseong-gun, Chungcheongnarn-do (KR)

(72) Inventor: Jung Cheol LEE, Hongseong-gun (KR)

(73) Assignee: NEOVIEW KOLON CO., LTD., Hongseong-gun, Chungcheongnam-do (KR)

(21) Appl. No.: 15/102,579

(22) PCT Filed: Nov. 19, 2014
(86) PCT No.: PCT/KR2014/011103

§ 371 Date: Jun. 8, 2016

(30) Foreign Application Priority Data
Dec. 10, 2013 (KR) 10-2013-0153200
Dec. 12, 2013 (KR) 10-2013-0154428

(51) Int. Cl. G09G 3/3233; G09G 3/3291; G09G 3/3266

(52) U.S. Cl. CPC G09G 3/3233; G09G 3/3266; G09G 3/3291; G09G 2320/045; G09G 2320/048; G09G 2300/0426; G09G 2320/0646; G09G 2310/0251

(57) ABSTRACT

Disclosed are an apparatus and a method for compensating for a fluctuation in threshold voltage due to a deterioration of a driving transistor included in pixel circuits of an OLED device. The OLED device includes a plurality of pixel circuits which are disposed at areas in which a plurality of gate lines supplying row selecting signals and a plurality of data lines supplying image signals. The individual pixel circuit includes an OLED device, a driving transistor; a switching transistor; a first capacitor; and a second capacitor, and the driving transistor applies a current corresponding to a summed voltage of a voltage charged in the first capacitor and a voltage charged in the second capacitor to the OLED, such that the OLED emits light at luminance corresponding to the current.

### TECHNICAL FIELD

The present invention relates to an apparatus and a method for compensating for a luminance difference of an organic light-emitting display device, and more particularly, to an apparatus and a method for compensating for a luminance difference of an organic light-emitting display device using an organic electroluminescence device as a display element for a pixel of a display device.

### BACKGROUND ART

Recently, an organic light-emitting display device using an organic electroluminescence device (hereinafter referred to as an ‘organic EL device’) as a pixel for a display device has been in the limelight. Herein, the organic light-emitting display device using the organic EL device as a light-emitting device is lightweight and thin and has more excellent luminance and viewing angle characteristics than other display devices, and therefore has drawn attention as a next-generation flat panel display device.

The organic EL device is a light-emitting device which has a structure in which an organic light-emitting layer including organic compounds is inserted between a pair of electrodes including an anode and a cathode which are formed on a transparent substrate such as glass, or the like and performs a display, or the like by using light emission when activation of excitons generated by injecting holes and electrons into the organic light-emitting layer from the pair of electrodes and then recombining the holes with the electrons is lost.

The organic light-emitting layer is a thin film layer formed of organic materials and a color of the emitted light and a conversion efficiency converting a current into light are determined by a composition of the organic materials forming the organic light-emitting layer, whereby organic light-emitting layers of different organic materials from each other generate different colors from each other.

However, when the display device is used for a long period of time, the light-emitting efficiency is reduced due to deterioration of the organic materials, and thereby the lifespan of the display device is shortened. In this case, the different organic materials may be deteriorated at different rates from each other depending on the color of the emitted light, and there may be a difference in the level of deterioration of colors, for example.

Also, each of the plurality of pixels included in the display device may not be deteriorated at the same rate as other pixels, and thus the difference in rates of degradation leads to non-uniformity of the display.

An example of the deterioration factors may include an increase in a resistance value of the device itself and a reduction in the light-emitting efficiency due to the usage of the display device for a long period of time. The organic EL device has characteristics that, when the organic EL device emits light for a long period time, the resistance value of the device is slowly increased, as well as each of the plurality of organic EL devices included in the display device has different light-emitting frequencies from each other and thus the accumulated light-emitting time cannot but be different from each other. Therefore, when the display device is driven for a long period of time, there may be a difference in the resistance value between the respective organic EL devices, which results in a deviation in the light-emitting luminance, and thereby uneven luminance over the entire screen, or image burn-in or a ghost image may occur.

As another factor of the deterioration, there is a reduction in the intensity of the emitted light due to an increase in threshold voltage in response to deterioration in light intensity with the passage of use time of a thin film transistor (TFT), in particular, a driving transistor included in the pixels. Meanwhile, an increase in the threshold voltage of the transistor is also different for each of the plurality of transistors in the display device.

A technique for solving the problem of the deterioration due to the usage of the display device for a long period of time is disclosed in Patent Document 1.

FIG. 1 is a circuit diagram illustrating a configuration of a driving circuit for a display device disclosed in Patent Document 1.

As illustrated in FIG. 1, a conventional driving circuit for a display device includes a pixel circuit 60 including a selective transistor 90, a driving transistor 70, and an organic EL device 50, a first voltage source 14, a first switch S1 selectively connecting the first voltage source 14 to a first electrode of the driving transistor 70, an organic EL device 50 of which an anode is connected to a second electrode of the driving transistor 70, a second voltage source 15, and a second switch S2 selectively connecting a cathode of the organic EL device 50 to the second voltage source 15.

Further, the first electrode includes a lead out transistor 80 connected to the second electrode of the driving transistor 70, a current source 16, a third switch S3 selectively connecting the current source 16 to a second electrode of the lead out transistor 80, a current sink 17, a fourth switch S4 selectively connecting the current sink 17 to a second electrode of the lead out transistor 80, and a voltage measuring circuit 18 connected to the second electrode of the lead out transistor 80 to measure a voltage when a test voltage is applied to a gate electrode of the driving transistor 70.

The voltage measuring circuit 18 includes an A/D converter 18a for converting the measured voltage value into a digital signal, a processor 18b, and a memory 18c storing the measured voltage value, and is connected to the second electrode of the plurality of lead out transistors 80 through a multiplexer 40 to sequentially read a voltage Vout from the pixel circuit 60.

The processor 18b is connected to a data line of the pixel circuit 60 through a D/A converter 18e which converts a digital signal into an analog signal to provide a prescribed data value to the data line. Further, the processor 18b receives display data Data input from an input terminal thereof to compensate for changes to be described below and thus provides the compensation data to the data line.

Next, a method for compensating for changes in characteristics of the display device disclosed in Patent Document 1 will be briefly described.

First, the first switch S1 and the fourth switch S4 are closed and the second switch S2 and the third switch S3 are open, and thus the voltage at the second electrode of the lead out transistor 80 is measured using the voltage measuring circuit 18 to obtain a first signal V1 indicating the characteristics of the driving transistor 70.

FIG. 1 illustrates only one of the plurality of pixels of the display device, but the first signal is measured for each of the plurality of pixels included in the display device.

The first signal V1 is measured once, for example, before the pixel circuit 60 is used as the display device, that is, before the driving transistor is deteriorated due to the usage thereof, and thus the measured first signal is stored in a memory 18c as a first target signal. Then, after the pixel circuit is deteriorated by use as a display device for a predetermined time, the first signal is measured by the same method as the above-described method and the measured first signal is stored in the memory 18c.

Next, the first switch S1 and the fourth switch S4 are open and the second switch S2 and the third switch S3 are closed, and thus the voltage at the second electrode of the lead out transistor 80 is measured using the voltage measuring circuit 18 to obtain a second signal V2 indicating the characteristics of the organic EL device 50.

The second signal V2 is measured for each of the plurality of pixels included in the display device, and similar to the first signal, the second signal V2 is measured and stored in the memory 18c before the display device is used, that is, the organic EL device 50 is deteriorated due to the usage thereof and after the organic EL device is deteriorated by use as a display device for a predetermined time, respectively.

Next, the changes in characteristics of the driving circuit are compensated by using the changes in the first signal and the second signal.

In addition, Patent Document 2 discloses a display device which includes: a voltage sensing circuit including a transistor for sensing a voltage across each organic EL device of the organic light-emitting display device to generate feedback signals; and a controller for calculating a correction signal for each organic EL device and applying the calculated correction signal to data used to drive each organic EL device to compensate for changes in output of each organic EL device.

The conventional organic light-emitting display devices disclosed in Patent Documents 1 and 2 compensate for a luminance difference of the display device by comparing the characteristic values of the driving transistor and/or the organic EL device before and after the deterioration.

In general, the driving transistor and the organic EL device of the organic light-emitting display device are continuously deteriorated due to the usage thereof. However, the techniques disclosed in Patent Documents 1 and use the difference in characteristic values of the transistor and/or organic EL device before and after the deterioration to compensate for the luminance difference, and there is a considerable time difference in the measurement time before and after the deterioration, and thus the luminance of the organic light-emitting display device is continuously reduced during measuring. Therefore, as a result thereof, the techniques disclosed in Patent Documents 1 and 2 may not immediately compensate for the deterioration.

Further, Patent Document 2 does not consider the deterioration of the driving transistor which is one of the factors of the reduction in characteristics due to the usage of the display device, and therefore it is not possible to completely solve the problem of the performance deterioration due to the usage of the display device for a long period of time.

### PRIOR ART DOCUMENT

### Patent Document

Patent Document1: International Patent Laid-open Publication No. WO2009/002406 (published on Dec. 31, 2008)

Patent Document2: Japanese Patent Application Publication No. 2007-514966 (published on Jun. 7, 2007)

### DISCLOSURE

### Technical Problem

In consideration of the above-described circumstances, it is an object of the present invention to provide an apparatus and a method for compensating for a luminance difference of an organic light-emitting display device capable of emitting light at constant luminance at all times independent of the passage of use time of the display device by measuring a threshold voltage of a driving transistor included in each pixel of the organic light-emitting display device whenever the driving transistor emits light and applying a voltage reflecting the measured value to the driving transistor.

### Technical Solution

To achieve the above objects, according to an aspect of the present invention, there is provided an apparatus for compensating for a luminance difference of an organic light-emitting display device including a plurality of pixel circuits which are disposed at areas in which a plurality of gate lines supplying scanning signals and a plurality of data lines supplying image signals intersect each other, wherein each of the plurality of pixel circuits includes: a light-emitting device; a driving transistor configured to control a current flowing in the light emitting device depending on an image signal applied through the data line; a switching transistor connected between a gate electrode of the driving transistor and the data line, and configured to control a conduction state depending on the scanning signal; a first capacitor being charged with a threshold voltage of the driving transistor; and a second capacitor being charged with a voltage corresponding to the image signal, and the driving transistor may apply a current corresponding to a summed voltage of the voltage charged in the first capacitor and the voltage charged in the second capacitor to the light-emitting device.

According to another aspect of the present invention, there is provided an apparatus for compensating for a luminance difference of an organic light-emitting display device including a plurality of pixel circuits which are disposed at areas in which a plurality of gate lines supplying scanning signals and a plurality of data lines supplying image signals intersect each other, wherein each of the plurality of pixel circuits includes: a light-emitting device; a driving transistor configured to control a current flowing in the light emitting device depending on an image signal applied through the data line; a switching transistor connected between a gate electrode of the driving transistor and the data line, and configured to control a conduction state depending on the scanning signal; a third capacitor being charged with a threshold voltage of the driving transistor; a fourth capacitor being charged with a summed voltage of a voltage corresponding to the image signal and a threshold voltage of the driving transistor charged in the third capacitor, and the driving transistor applies a current corresponding to the voltage charged in the fourth capacitor to the light-emitting device.

According to another aspect of the present invention, there is provided a method for compensating for a luminance difference of an organic light-emitting display device including a plurality of pixel circuits which are disposed at areas in which a plurality of gate lines supplying scanning signals and a plurality of data lines supplying image signals intersect each other, wherein each of the plurality of pixel circuits includes: a light-emitting device; a driving transistor configured to control a current flowing in the light emitting device depending on an image signal applied through the data line; a switching transistor connected between a gate electrode of the driving transistor and the data line, and configured to control a conduction state depending on the scanning signal; and first and second capacitors, the method including: charging the first capacitor with a threshold voltage of the driving transistor; charging the second capacitor with a voltage corresponding to the image signal; and applying a current corresponding to a summed voltage of a voltage charged in the first capacitor and a voltage charged in the second capacitor to the light-emitting device.

According to another aspect of the present invention, there is provided a method for compensating for a luminance difference of an organic light-emitting display device including a plurality of pixel circuits which are disposed at areas in which a plurality of gate lines supplying scanning signals and a plurality of data lines supplying image signals intersect each other, wherein each of the plurality of pixel circuits includes a light-emitting device; a driving transistor configured to control a current flowing in the light emitting device depending on an image signal applied through the data line; a switching transistor connected between a gate electrode of the driving transistor and the data line, and configured to control a conduction state depending on the scanning signal; and third and fourth capacitors, the method including: charging the third capacitor with a threshold voltage of the driving transistor; charging the fourth capacitor with a summed voltage of a voltage corresponding to the image signal and a threshold voltage of the driving transistor charged in the third capacitor, and applying a current corresponding to a voltage charged in the fourth capacitor to the light-emitting device.

### Advantageous Effects

According to the embodiments of the present invention, the organic EL device which is the light-emitting device emits light by making a current corresponding to a summed voltage of the threshold voltages of the driving transistors of each pixel circuit flowing in the image signals be applied to each pixel circuit, such that the light-emitting device may emit light at proper luminance at all times independent of the deterioration with the passage of use time of the driving transistor of the display device.

### DESCRIPTION OF DRAWINGS

FIG. 1 is a circuit diagram illustrating a configuration of a driving circuit for a conventional display device.

FIG. 2 is a diagram schematically illustrating a configuration of a display device according to Embodiment 1 of the present invention.

FIG. 3 is a circuit diagram schematically illustrating a configuration of a pixel circuit of the display device according to Embodiment 1 of the present invention.

FIG. 4 is a diagram illustrating an operating timing of the display device according to Embodiment 1 of the present invention.

FIG. 5 is a diagram illustrating the configuration of the pixel circuit at the time of a turn off operation of an organic EL device according to Embodiment 1 of the present invention.

FIG. 6 is a diagram illustrating the configuration of the pixel circuit at the time of detecting a threshold voltage of a driving transistor according to Embodiment 1 of the present invention.

FIG. 7 is a diagram illustrating the configuration of the pixel circuit at the time of applying a row selecting signal according to Embodiment 1 of the present invention.

FIG. 8 is a diagram illustrating the configuration of the pixel circuit at the time of a turn on of the organic EL device according to Embodiment 1 of the present invention.

FIG. 9 is a circuit diagram schematically illustrating a configuration of a pixel circuit of a display device according to Embodiment 2 of the present invention.

FIG. 10 is a diagram illustrating an operating timing of the display device according to Embodiment 2 of the present invention.

FIG. 11 is a diagram illustrating the configuration of the pixel circuit at the time of a turn off operation of an organic EL device according to Embodiment 2 of the present invention.

FIG. 12 is a diagram illustrating the configuration of the pixel circuit at the time of detecting a threshold voltage of a driving transistor according to Embodiment 2 of the present invention.

FIG. 13 is a diagram illustrating the configuration of the pixel circuit at the time of applying a row selecting signal according to Embodiment 2 of the present invention.

FIG. 14 is a diagram illustrating the configuration of the pixel circuit at the time of a turn on of the organic EL device according to Embodiment 2 of the present invention.

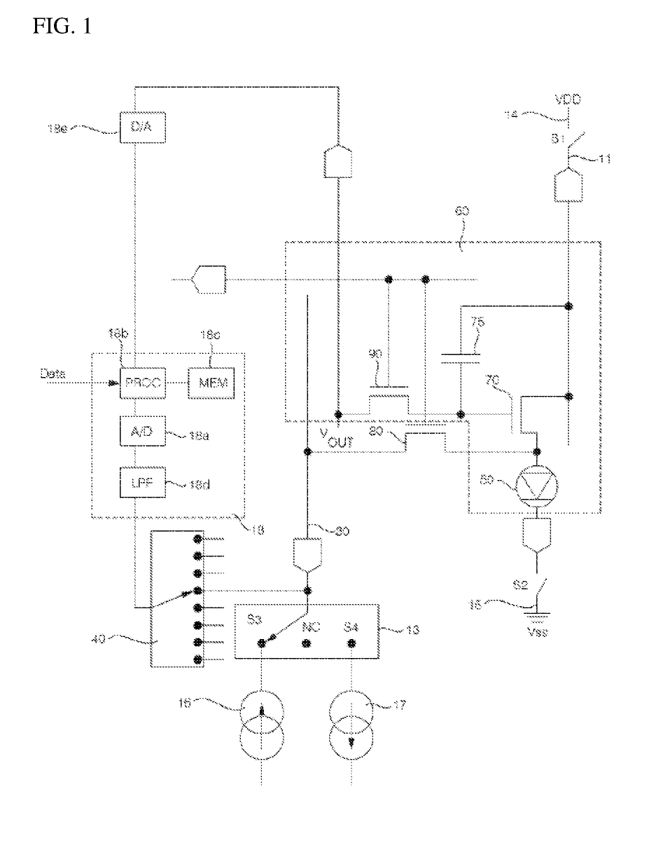

### BEST MODE

Hereinafter, exemplary embodiments of the present invention will be described in detail with reference to the accompanying drawings.

### 1. Embodiment 1

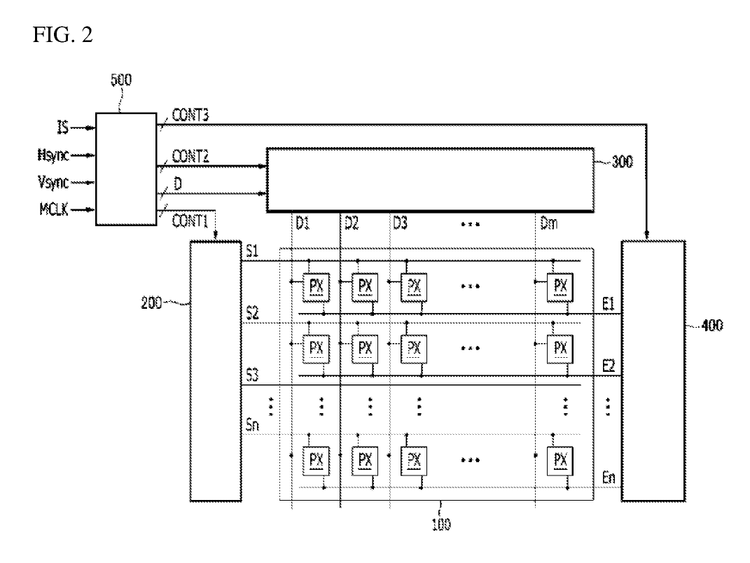

First, Embodiment 1 of the present invention will be described. FIG. 2 is a diagram schematically illustrating a configuration of an organic light-emitting display device (hereinafter also briefly referred to as a ‘display device’) according to Embodiment 1 of the present invention.

As illustrated in FIG. 2, the display device according to Embodiment 1 of the present invention includes a display unit 100, a gate driver 200, a data driver 300, an anode driver 400, and a control unit 500.

The display unit 100 includes a plurality of gate lines S1 to Sn which are disposed in parallel with each other and supply row selecting signals SCAN for selecting one of a plurality of rows, a plurality of data lines D1 to Dm which are disposed substantially orthogonal to the gate lines S1 to Sn and supply an image signal Vdata to a selected pixel circuit, and a plurality of anode lines E1 to En which supply light-emitting signals to the selected pixel circuit. Herein, the plurality of gate lines S1 to Sn and the plurality of anode lines E1 to En are arranged in parallel with each other.

A plurality of pixel circuits P×10 are arranged at each intersecting point in which the plurality of gate lines S1 to Sn and the plurality of data lines D1 to Dm intersect each other in a matrix form.

The gate driver 200 is connected to the gate lines S1 to Sn of the display unit 100 and applies sequential row selecting signals (scanning signals) SCAN to the gate lines S1 to Sn depending on a scanning control signal CONT1 supplied from the control unit 500.

The data driver 300 is connected to the data lines D1 to Dm of the display unit 100 and generates the image signal Vdata corresponding to an image data signal D input from the control unit 500 depending on a data control signal CONT2 supplied from the control unit 500 to sequentially apply the generated image signal Vdata to each data line D1 to Dm.

The anode driver 400 is connected to the anode lines E1 to En of the display unit 100 and sequentially applies light-emitting signals to the anode lines E1 to En depending on a light-emitting control signal CONT3 supplied from the control unit 500.

The control unit 500 receives an input signal IS, a horizontal synchronous signal Hsync, a vertical synchronous signal Vsync, and a main clock signal MCLK from an outside thereof, and generates the image data signal D, the scanning control signal CONT1, the data control signal CONT2, and the light-emitting control signal CONT3 to apply the generated signals to the gate driver 200, the data driver 300, and the anode driver 400, respectively.

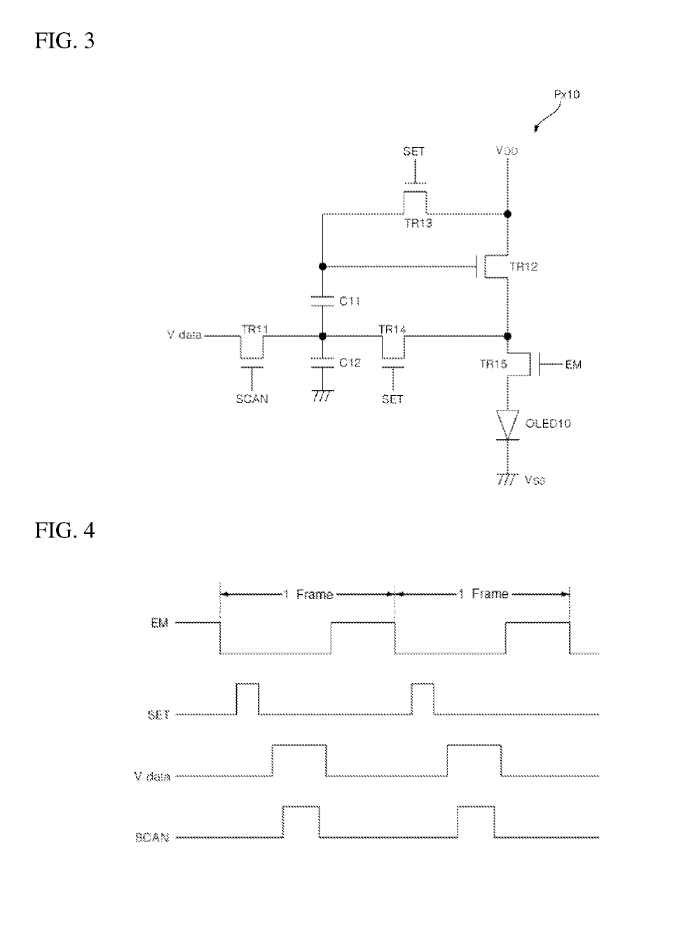

Next, a configuration of the pixel circuit P×10 will be described. FIG. 3 is a circuit diagram schematically illustrating a configuration of the pixel circuit P×10 of the display unit 100 of the display device according to Embodiment 1 of the present invention.

As illustrated in FIG. 3, the pixel circuit P×10 according to Embodiment 1 of the present invention includes an organic EL device OLED10, five transistors which include a switching transistor TR11, a driving transistor TR12, a first setting transistor TR13, a second setting transistor TR14, and a light-emitting control transistor TR15, and two capacitors which include a first capacitor C11 and a second capacitor C12.

Each transistor TR11, TR12, TR13, TR14, and TR15 has a first electrode, a second electrode, and a gate electrode.

A gate electrode of the switching transistor TR11 is connected to the gate driver (gate driver 200 of FIG. 2), which is not illustrated in FIG. 3, via the gate line, a first electrode thereof is connected to the data driver (data driver 300 of FIG. 2), which is not illustrated in FIG. 3, via the data line, a second electrode thereof is connected to a gate electrode of the driving transistor TR12 via the first capacitor C11 and a first electrode of the second setting transistor TR14, and the second electrode thereof is also connected to one terminal of the second capacitor C12. Herein, the other terminal of the second capacitor C12 is connected to a second voltage source Vss.

The switching transistor TR11 having the above-described connection relationship is turned on by the row selecting signal (scanning signal) SCAN applied from the gate driver to output the image signal Vdata applied from the data driver to the gate electrode of the driving transistor TR12 via the first capacitor C11.

A first electrode of the driving transistor TR12 is connected to a first voltage source VDD and a first electrode of the first setting transistor TR13, a second electrode thereof connected is to an anode terminal of the organic EL device OLED10 via the light-emitting control transistor TR15 and a second electrode of the second setting transistor TR14, and the gate electrode thereof is connected to the second electrode of the switching transistor TR11 via the first capacitor C11.

The driving transistor TR12 connected as described above is turned on by the image data Vdata supplied through the switching transistor TR11 to supply a voltage applied from the first voltage source VDD to the organic EL device OLED10. In this case, a current flowing in the organic EL device OLED10 is a current corresponding to a magnitude of the image signal Vdata, such that the organic EL device OLED10 emits light at luminance corresponding to the magnitude of the current flowing in the above device.

The first electrode of the first setting transistor TR13 is connected to the first voltage source VDD and the first electrode of the driving transistor TR12, the second electrode thereof is connected to one terminal of the first capacitor C11 and the gate electrode of the driving transistor TR12, and the gate electrode thereof is connected to a control unit (not illustrated).

The first electrode of the second setting transistor TR14 is connected to the second electrode of the switching transistor TR11 and the other terminal of the first capacitor C11, the second electrode thereof is connected to the second electrode of the driving transistor TR12 and a first electrode of the light-emitting control transistor TR15, and the gate electrode thereof is connected to the control unit (not illustrated). Further, the first electrode of the second setting transistor TR14 is connected to the second voltage source Vss via the second capacitor C12.

The first setting transistor TR13 and the second setting transistor TR14 are operated at the time of detecting a threshold voltage of the driving transistor TR12 and an operation thereof will be described in detail below.

The first electrode of the light-emitting control transistor TR15 is connected to the first voltage source VDD via the driving transistor TR12 and the second electrode of the second setting transistor TR14, the second electrode thereof is connected to the anode electrode of the organic EL device OLED10, and the gate electrode thereof is connected to the control unit (not illustrated).

The control unit which is connected to the gate electrodes of the first setting transistor TR13, the second setting transistor TR14, and the light-emitting control transistor TR15 may be configured so that the functions thereof are simultaneously performed by the control unit (control unit 500 of FIG. 2) which controls the overall operation of the organic light-emitting display device including the gate driver and the data driver, or may be configured as a separate control unit from the control unit 500 of FIG. 2.

Next, an operation of the organic light-emitting display device according to Embodiment 1 of the present invention will be described with reference to FIGS. 4 to 8.

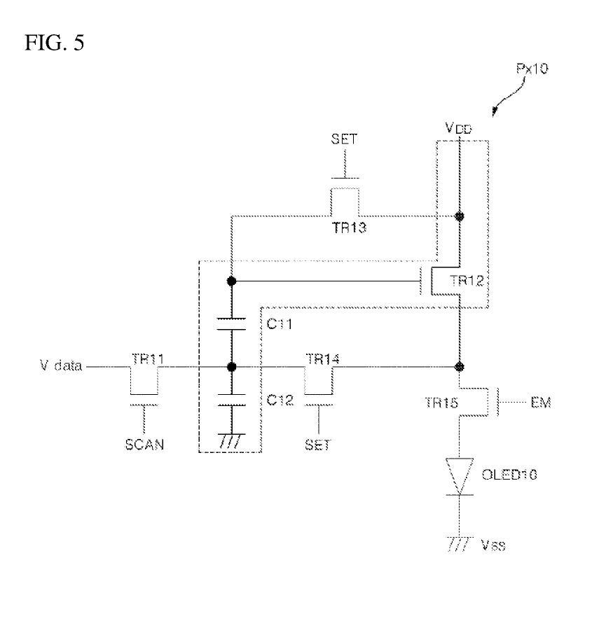

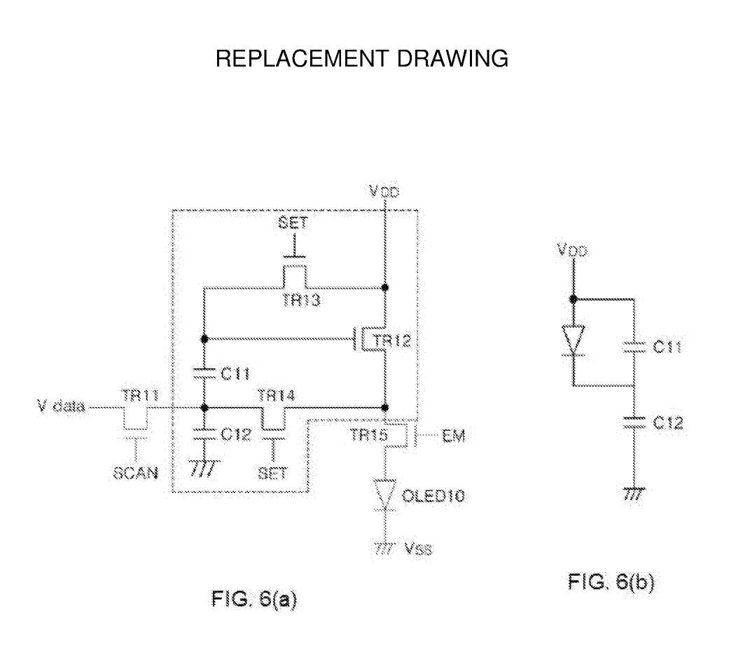

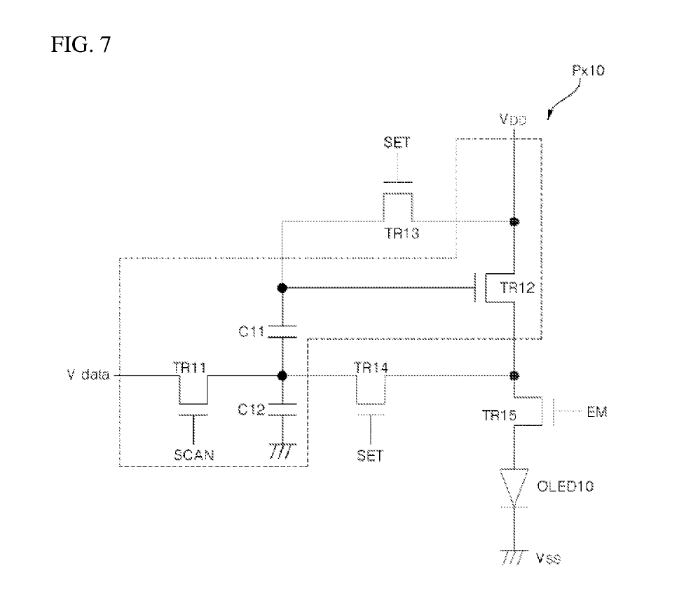

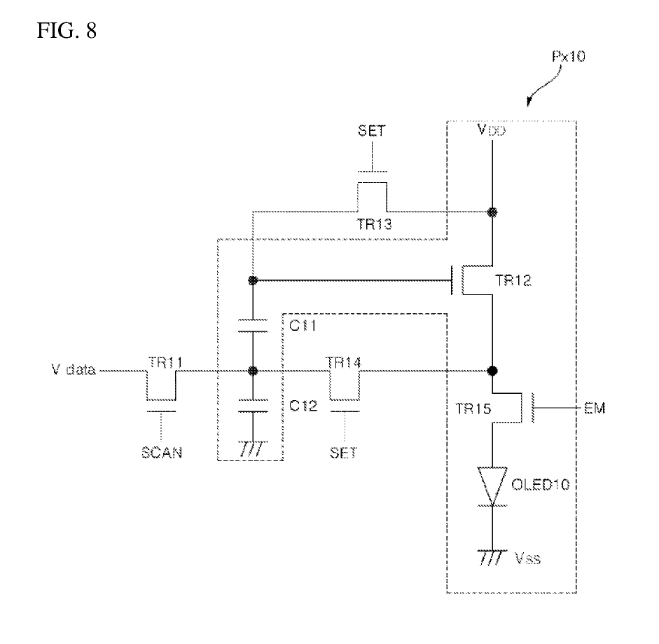

FIG. 4 is a diagram illustrating an operating timing of the pixel circuit P×10 according to Embodiment 1 of the present invention, FIG. 5 is a diagram illustrating the configuration of the pixel circuit P×10 at the time of a turn off operation of the organic EL device OLED10 according to Embodiment 1 of the present invention, FIG. 6 is a diagram illustrating the configuration of the pixel circuit P×10 at the time of detecting the threshold voltage of the driving transistor TR12 according to Embodiment 1 of the present invention, FIG. 7 is a diagram illustrating the configuration of the pixel circuit P×10 at the time of applying the row selecting signal SCAN according to Embodiment 1 of the present invention, and FIG. 8 is a diagram illustrating the configuration of the pixel circuit P×10 at the time of a turn on of the organic EL device OLED10 according to Embodiment 1 of the present invention.

First, as illustrated in the timing diagram of FIG. 4, the control unit (not illustrated) in a first half part of frame period sets a voltage EM applied to the gate electrode of the light-emitting control transistor TR15 to be at a low level to turn off the light-emitting control transistor TR15, such that the anode electrode of the organic EL device OLED10 and the first voltage source VDD are turned off and thus the organic EL device OLED10 is turned off (see FIG. 5).

Then, when the control unit (not illustrated) applies a voltage SET to the gate electrodes of the first setting transistor TR13 and the second setting transistor TR14 in the state in which the organic EL device OLED10 is turned off, the first setting transistor TR13 and the second setting transistor TR14 are in a turn on state, and thus a closed circuit surrounded by a dotted line of FIG. 6A is formed.

In detail, the first setting transistor TR13 is turned on and thus the first electrode and the gate electrode of the driving transistor TR12 are in a short state, such that the driving transistor TR12 is in a diode state. Representing this condition by an equivalent circuit, the portion surrounded by the dotted line of FIG. 6A may be illustrated as a state of FIG. 6B.

Herein, a voltage applied across a diode of the equivalent circuit becomes a gate-source voltage Vgs of the driving transistor TR12, and finally, the first capacitor C11 is charged with a voltage having the same magnitude as a threshold voltage Vth of the driving transistor TR12.

Next, as illustrated in FIG. 4, the control unit (not illustrated) sets the voltage SET applied to the gate electrodes of the first setting transistor TR13 and the second setting transistor TR14 to be at a low level. Then, when the image signal Vdata is applied from the data driver to the first electrode of the switching transistor TR11 and the row selecting signal SCAN is applied to the gate electrode of the switching transistor TR11, the switching transistor TR11 is in a turn on state, and the pixel circuit P×10 forms a closed circuit as surrounded by a dotted line of FIG. 7.

Thereby, the voltage corresponding to the image signal Vdata applied from the data driver is charged in the second capacitor C12.

Thereafter, when the control unit sets the row selecting signal SCAN and the image signal Vdata applied to the switching transistor TR11 to be at a low level and sets the voltage EM applied to the gate electrode of the light-emitting control transistor TR15 to be at a high level (this period becomes a second half part of 1 frame period of the pixel circuit P×10), the pixel circuit P×10 forms a closed circuit surrounded by a dotted line of FIG. 8.

Accordingly, the gate electrode of the driving transistor TR12 is applied with a summed voltage in which the voltage charged in the first capacitor C11 and the second capacitor C12, that is, the voltage corresponding to the magnitude of the image signal Vdata applied from the data driver is added to the threshold voltage of the driving transistor TR12, and when the light-emitting control transistor TR15 is turned on, a current corresponding to the summed voltage flows in the organic EL device OLED10 from the first voltage source VDD and the organic EL device OLED10 emits light at luminance corresponding to the magnitude of the current.

Even though a specific pixel circuit P×10 among the plurality of pixel circuits included in the display unit 100 is described above, however each of the plurality of pixel circuits is operated by any method known in the related art depending on each signal applied from the gate driver 200, the data driver 300, and the anode driver 400 by the control of the control unit 500 to compensate for the threshold voltage due to the deterioration of the driving transistor TR12 of each pixel circuit P×10 which is a subject of the present invention, and thereby driving the organic EL device OLED10 which is the light-emitting device.

As described above, since the display device according to Embodiment 1 of the present invention makes the current corresponding to the summed voltage in which the threshold voltage of the driving transistor TR12 of each pixel circuit P×10 is added to the image signal Vdata applied from the data driver 300 flow in the organic EL device OLED10, the organic EL device OLED10 which is the light-emitting device may emit light at proper luminance at all times independent of the deterioration of the driving transistor TR12 due to the usage thereof for a long period of time.

### 2. Embodiment 2

Next, Embodiment 2 of the present invention will be described.

The overall configuration of an organic light-emitting display device according to Embodiment 2 of the present invention is the same as that of the organic light-emitting display device according to the above-described Embodiment 1, except that a configuration and an operation of a pixel circuit included in a display unit according to Embodiment 2 is different from those of the pixel circuit according to Embodiment 1.

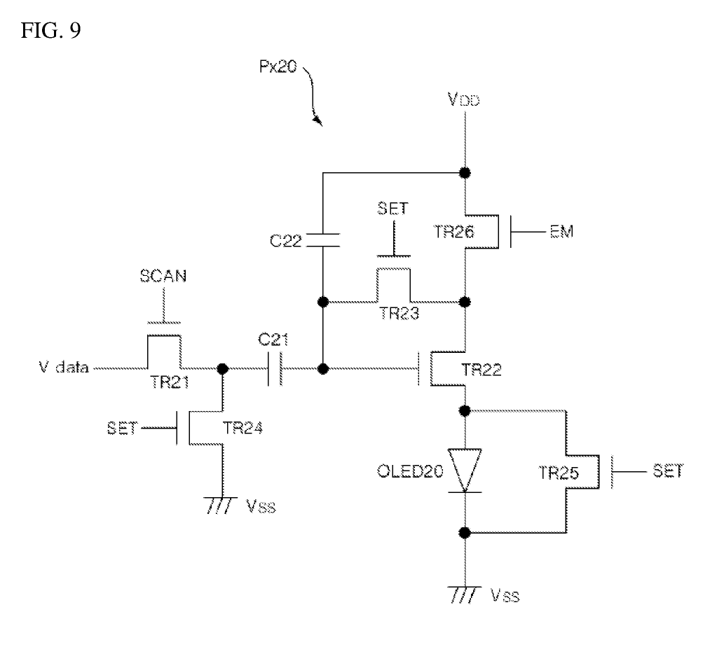

Therefore, the configuration and the operation of a pixel circuit P×20 according to Embodiment 2 of the present invention will be mainly described below. FIG. 9 is a circuit diagram schematically illustrating the configuration of a pixel circuit P×20 of the display unit 100 of the display device according to Embodiment 2 of the present invention.

As illustrated in FIG. 9, the pixel circuit P×20 according to Embodiment 2 of the present invention includes an organic EL device OLED20, sixth transistors which include a switching transistor TR21, a driving transistor TR22, a third setting transistor TR23, a fourth setting transistor TR24, a fifth setting transistor TR25, and a light-emitting control transistor TR26, and two capacitors which include a third capacitor C21 and a fourth capacitor C22.

Each transistor TR21, TR22, TR23, TR24, TR25, and TR26 has a first electrode, a second electrode, and a gate electrode.

A gate electrode of the switching transistor TR21 is connected to the gate driver (gate driver 200 of FIG. 2), which is not illustrated in FIG. 9, via the gate line, a first electrode thereof is connected to the data driver (data driver 300 of FIG. 2), which is not illustrated in FIG. 9, via the data line, and a second electrode thereof is connected to a gate electrode of the driving transistor TR22 via the third capacitor C21 and a first electrode of the third setting transistor TR23 and one terminal of the fourth capacitor C22. Further, the second electrode of the switching transistor TR21 is also connected to a first electrode of the fourth setting transistor TR24.

One terminal of the third capacitor C21 is connected to the second electrode of the switching transistor TR21 and the first electrode of the fourth setting transistor TR24, the other terminal thereof is connected to a gate electrode of the driving transistor TR22, one terminal of the fourth capacitor C22, and the first electrode of the third setting transistor TR23, and the other terminal of the fourth capacitor C22 is connected to the first voltage source VDD and a first electrode of the light-emitting control transistor TR26.

The switching transistor TR21 having the above-described connection relationship is turned on by the row selecting signal (scanning signal) SCAN applied from the gate driver to charge a summed voltage of the image signal Vdata applied from the data driver and the threshold voltage Vth of the driving transistor TR22 charged in the third capacitor C21 to be described below in the fourth capacitor C22, and apply the charged voltage to the gate electrode of the driving transistor TR22.

A first electrode of the driving transistor TR22 is connected to the first voltage source VDD via the light-emitting control transistor TR26 and a second electrode of the third setting transistor TR23. Further, the second electrode of the driving transistor TR22 is connected to an anode terminal of the organic EL device OLED20 and a first electrode of the fifth setting transistor TR25, and the gate electrode thereof is connected to the second electrode of the switching transistor TR21 via the third capacitor C21.

The driving transistor TR22 connected as described above is turned on by the image signal Vdata supplied through the switching transistor TR21 to supply the voltage applied from the first voltage source VDD to the organic EL device OLED20.

The first electrode of the third setting transistor TR23 is connected to the gate electrode of the driving transistor TR22 and the other terminal of the third capacitor C21 simultaneously with being connected to the first voltage source VDD via the fourth capacitor C22, the second electrode thereof is connected to the first electrode of the driving transistor TR22 and the second electrode of the light-emitting control transistor TR26, and the gate electrode thereof is connected to a control unit (not illustrated).

The first electrode of the fourth setting transistor TR24 is connected to the second electrode of the switching transistor TR21 and one terminal of the third capacitor C21, a second electrode thereof is connected to the second voltage source Vss, and a gate electrode thereof is connected to the control unit (not illustrated).

The first and second electrodes of the fifth setting transistor TR25 are connected to an anode electrode and a cathode electrode of the organic EL device OLED20, respectively, and a gate electrode thereof is connected to the control unit (not illustrated). That is, the fifth setting transistor TR25 is connected to the organic EL device OLED20 in parallel and when the fifth setting transistor TR25 is in a turn on state, the organic EL device OLED20 is in a turn off state, and thereby a bypass line is formed between the first voltage source VDD and the second voltage source Vss.

The third setting transistor TR23, the fourth setting transistor TR24, and the fifth setting transistor TR25 are operated at the time of detecting a threshold voltage of the driving transistor TR22 and an operation thereof will be described in detail below.

The first electrode of light-emitting control transistor TR26 is connected to the first voltage source VDD and the other terminal of the fourth capacitor C22, a second electrode thereof is connected to the first electrode of the driving transistor TR22 and the second electrode of the third setting transistor TR23, and a gate electrode thereof is connected to the control unit (not illustrated).

The control unit which is connected to the gate electrodes of the third setting transistor TR23, the fourth setting transistor TR24, the fifth setting transistor TR25, and the light-emitting control transistor TR26 may be configured so that the functions thereof are simultaneously performed by the control unit (control unit 500 of FIG. 2) which controls the overall operation of the organic light-emitting display device including the gate driver and the data driver, or may be configured as a separate control unit from the control unit 500 of FIG. 2.

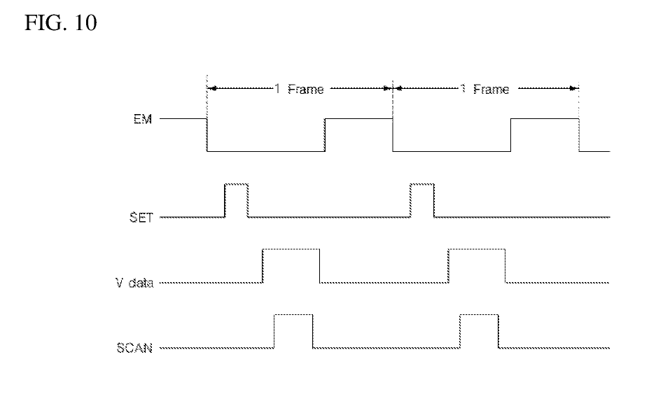

Next, an operation of the organic light-emitting display device according to Embodiment 2 of the present invention will be described with reference to FIGS. 10 to 14.

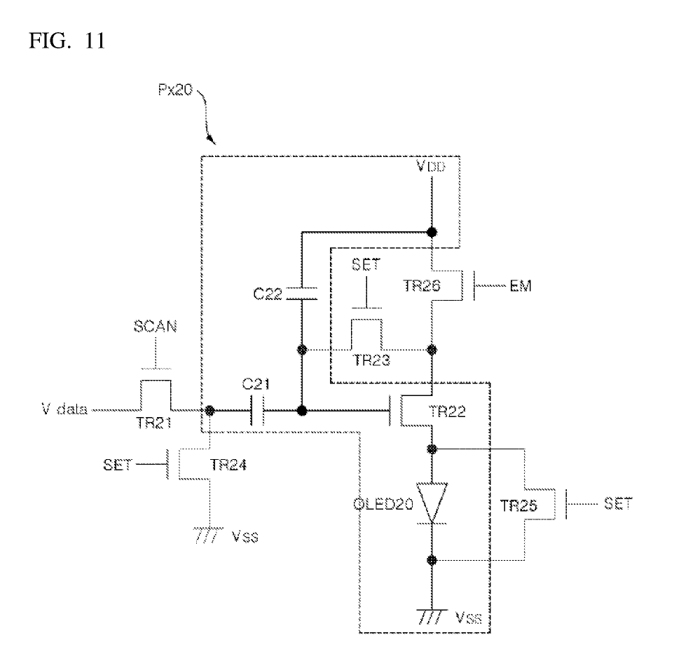

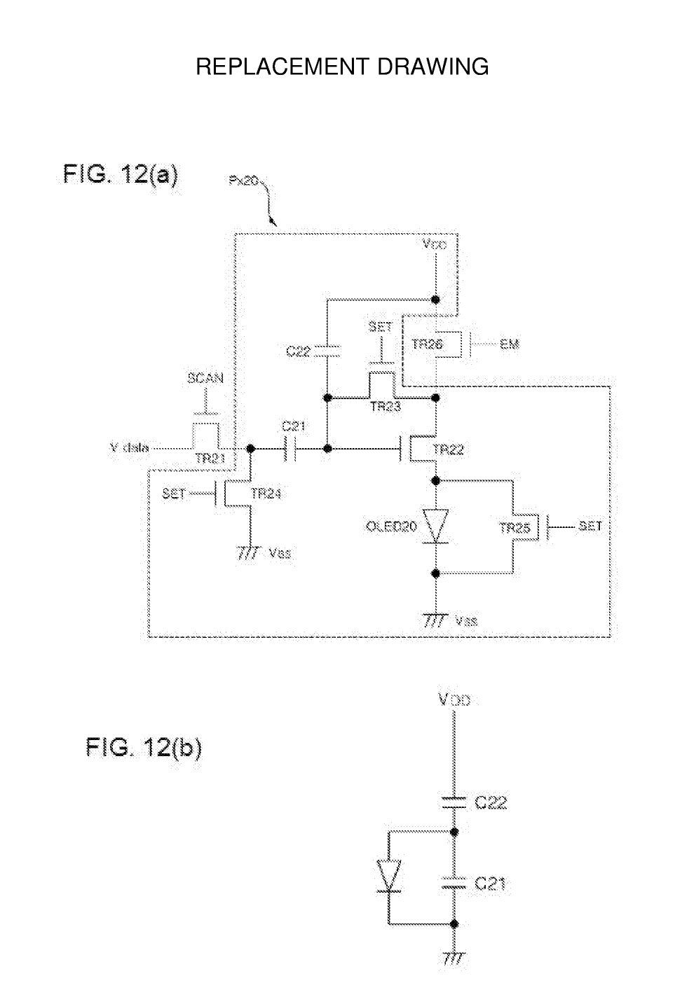

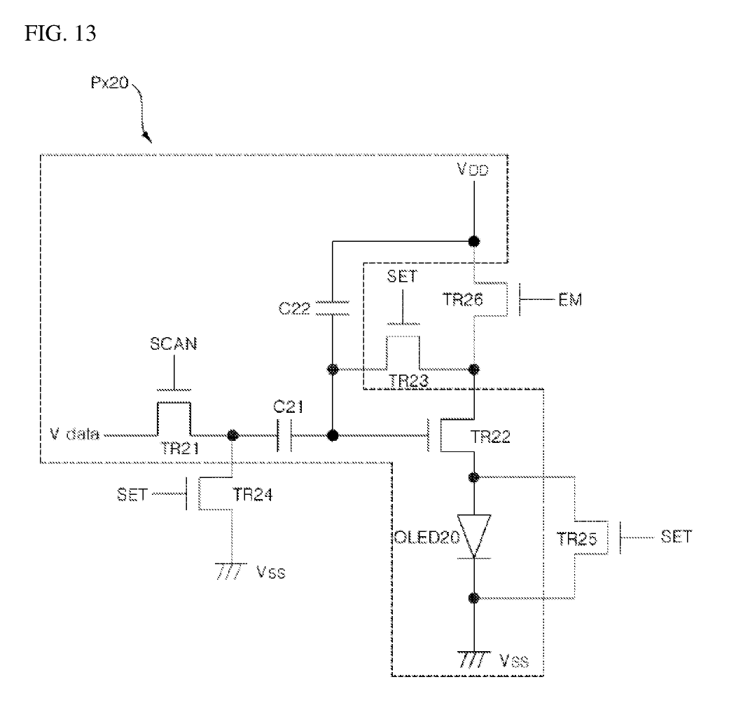

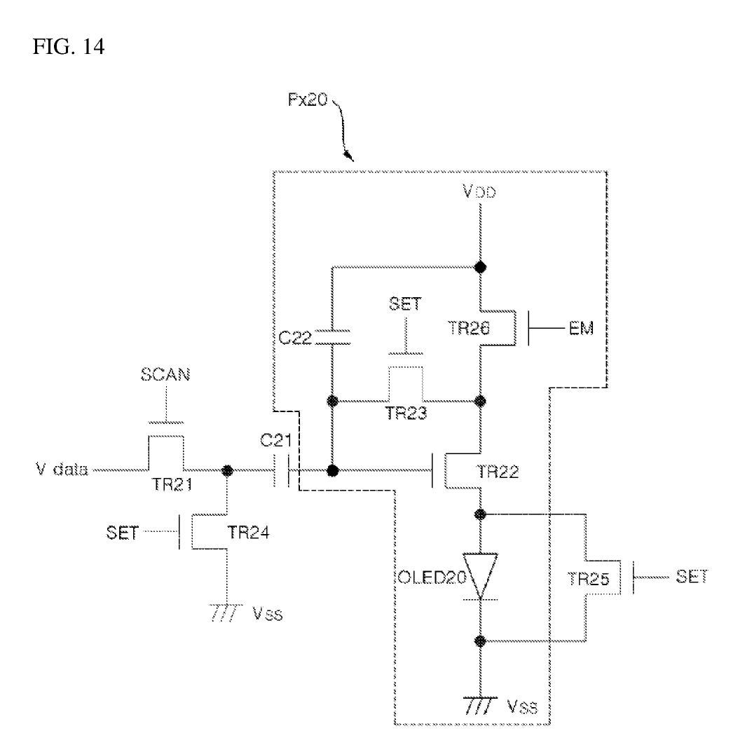

FIG. 10 is a diagram illustrating an operating timing of the pixel circuit P×20 according to Embodiment 2 of the present invention, FIG. 11 is a diagram illustrating the configuration of the pixel circuit P×20 at the time of a turn off operation of the organic EL device OLED20 according to Embodiment 2 of the present invention, FIG. 12 is a diagram illustrating the configuration of the pixel circuit P×20 at the time of detecting the threshold voltage of the driving transistor TR22 according to Embodiment 2 of the present invention, FIG. 13 is a diagram illustrating the configuration of the pixel circuit P×20 at the time of applying the row selecting signal SCAN according to Embodiment 2 of the present invention, and FIG. 14 is a diagram illustrating the configuration of the pixel circuit P×20 at the time of a turn on of the organic EL device OLED20 according to Embodiment 2 of the present invention.

First, as illustrated in the timing diagram of FIG. 10, the control unit (not illustrated) in a first half part of 1 frame period sets a voltage EM applied to the gate electrode of the light-emitting control transistor TR26 to be at a low level to turn off the light-emitting control transistor TR26, such that the organic EL device OLED20 is in the state in which it is not applied with voltage, that is, the organic EL device OLED20 is in a turn off state (see FIG. 11).

Then, when the control unit (not illustrated) applies a voltage SET to the gate electrodes of the third setting transistor TR23, the fourth setting transistor TR24, and the fifth setting transistor TR25 in the state in which the organic EL device OLED20 is turned off, the third setting transistor TR23, the fourth setting transistor TR24, and the fifth setting transistor TR25 are in a turn on state and thus a closed circuit surrounded by a dotted line of FIG. 12A is formed.

In detail, the first electrode and the gate electrode of the driving transistor TR22 are in a short state by turning on the third setting transistor TR23 and thus the driving transistor TR22 is in a diode state.

Further, the organic EL device OLED20 is in a turn off state by turning on the fifth setting transistor TR25 and the second electrode of the driving transistor TR22 is connected to the second voltage source Vss via the fifth setting transistor TR25 which is a bypass line, such that a closed circuit in which a diode formed of the third capacitor C21 and the gate electrode and the second electrode of the driving transistor TR22 is connected in series is formed between the first voltage source VDD and the second voltage source Vss.

Further, the fourth setting transistor TR24 is in a turn on state, and thus a closed circuit in which the fourth capacitor C22 is connected to the third capacitor C21 in series is formed between the first voltage source VDD and the second voltage source Vss.

As described above, a circuit such as a portion surrounded by a dotted line of FIG. 12A is formed between the first voltage source VDD and the second voltage source Vss. Representing this condition by an equivalent circuit, the portion surrounded by the dotted line of FIG. 12A may be illustrated as a state of FIG. 12B.

Herein, a voltage applied across a diode of the equivalent circuit becomes a gate-source voltage Vgs of the driving transistor TR22, and finally, the third capacitor C21 is charged with a voltage having the same magnitude as the threshold voltage Vth of the driving transistor TR22.

Next, as illustrated in FIG. 10, the control unit (not illustrated) sets the voltage SET applied to the gate electrodes of the third setting transistor TR23, the fourth setting transistor TR24, and the fifth setting transistor TR25 to be at a low level. Then, when the image signal Vdata is applied from the data driver to the first electrode of the switching transistor TR21 and the row selecting signal SCAN is applied to the gate electrode of the switching transistor TR21, the switching transistor TR21 is in a turn on state and the pixel circuit P×20 forms a closed circuit as surrounded by a dotted line of FIG. 13.

Thereby, a summed voltage Vth+Vdata of the voltage corresponding to the image signal Vdata applied from the data driver and the threshold voltage Vth of the driving transistor TR22 charged in the third capacitor C21 in the previous step is charged in the fourth capacitor C22.

Thereafter, when the control unit sets the row selecting signal SCAN and the image signal Vdata applied to the switching transistor TR21 to be at a low level and sets the voltage EM applied to the gate electrode of the light-emitting control transistor TR26 to be at a high level (this period becomes a second half part of 1 frame period of the pixel circuit P×20), the pixel circuit P×20 forms a closed circuit surrounded by the dotted line of FIG. 14.

Accordingly, the gate electrode of the driving transistor TR22 is applied with the summed voltage Vth+Vdata in which the voltage charged in the fourth capacitor C22, that is, the threshold voltage of the driving transistor TR22 which is the voltage charged in the third capacitor C21 is added to the voltage corresponding to the magnitude of the image signal Vdata applied from the data driver, and when the light-emitting control transistor TR26 is turned on, a current corresponding to the summed voltage Vth+Vdata flows in the organic EL device OLED20 from the first voltage source VDD, and thereby the organic EL device OLED20 emits light at luminance corresponding to the magnitude of the current.

Even though a specific pixel circuit P×20 among the plurality of pixel circuits included in the display unit 100 is described above, however each of the plurality of pixel circuits is operated by any method known in the related art depending on each signal applied from the gate driver 200, the data driver 300, and the anode driver 400 by the control of the control unit 500 to compensate for the threshold voltage due to the deterioration of the driving transistor TR22 of each pixel circuit P×20 which is a subject of the present invention, thereby driving the organic EL device OLED20 which is the light-emitting device.

Further, in the above description, an operation of the pixel circuit P×20 for 1 frame period is described, but all of the plurality of pixel circuits P×20 are identically operated in each frame period.

As described above, since the display device according to Embodiment 2 of the present invention makes the current corresponding to the summed voltage of the threshold voltage of the driving transistor TR22 of each pixel circuit P×20 and the image signal Vdata applied from the data driver 300 flow in the organic EL device OLED20, the organic EL device OLED20 which is the light-emitting device may emit light at proper luminance at all times independent of the deterioration of the driving transistor TR22 due to the usage thereof for a long period of time.

In the description of the above Embodiments 1 and 2, each transistor included in the pixel circuit is described as an n-channel type FET, it may be adopted to a p channel type FET. In case of the p channel type FET, levels of gate signals applied to the gate electrodes of each transistor are reversed to those in the case of an n channel type FET.

Although the present invention has been described in accordance with the embodiments shown, the present invention is not limited to the Embodiments 1 and 2, and many modifications and variations may be made by one of ordinary skill in the art without departing from the spirit and scope of the appended claims.

### DESCRIPTION OF REFERENCE NUMERALS

Px10, Px20 pixel circuit
OLED10, OLED20 organic EL device OLED
TR11, TR21 switching transistor
TR12, TR22 driving transistor
TR13 first setting transistor
TR14 second setting transistor
TR23 third setting transistor
TR24 fourth setting transistor
TR25 fifth setting transistor
TR15, TR26 light-emitting control transistor
C11 first capacitor
C12 second capacitor
C21 third capacitor
C22 fourth capacitor

1. An apparatus for compensating for a luminance difference of an organic light-emitting display device including a plurality of pixel circuits which are disposed at areas in which a plurality of gate lines supplying scanning signals and a plurality of data lines supplying image signals intersect each other,
wherein each of the plurality of pixel circuits comprises:
a light-emitting device;
a driving transistor configured to control a current flowing in the light emitting device depending on an image signal applied through the data line;
a switching transistor connected between a gate electrode of the driving transistor and the data line, and configured to control a conduction state depending on the scanning signal;
a first capacitor being charged with a threshold voltage of the driving transistor; and
a second capacitor being charged with a voltage corresponding to the image signal, and
the driving transistor applies a current corresponding to a summed voltage of the voltage charged in the first capacitor and the voltage charged in the second capacitor to the light-emitting device.

2. The apparatus of claim 1, further comprising:
a light-emitting control transistor disposed between the driving transistor and the light-emitting device, and configured to switch a current path through which a current flows in the light-emitting device,
wherein the first capacitor is charged with a voltage between the gate electrode and a second electrode of the driving transistor as a threshold voltage of the driving transistor in a state in which the switching transistor and the light-emitting control transistor are turned off.

3. The apparatus of claim 1, further comprising:
a light-emitting control transistor disposed between the driving transistor and the light-emitting device, and configured to switch a current path through which a current flows in the light-emitting device,
wherein the second capacitor is charged with a voltage corresponding to the image signal applied through the switching transistor in a state in which the light-emitting control transistor is turned off.

4. The apparatus of claim 2, further comprising:
a first setting transistor of which a first electrode and a second electrode are connected to a first electrode and the gate electrode of the driving transistor and one terminal of the first capacitor, respectively; and
a second setting transistor of which a first electrode and a second electrode are connected to the other terminal of the first capacitor and the second electrode of the driving transistor, respectively,
wherein the threshold voltage of the driving transistor is a voltage between the gate electrode and the second electrode of the driving transistor when the first setting transistor and the second setting transistor are in a conduction state.

5. The apparatus of claim 3, further comprising:
a first setting transistor in which a first electrode and a second electrode are connected to the first electrode and the gate electrode of the driving transistor and one terminal of the first capacitor, respectively; and
a second setting transistor of which a first electrode and a second electrode are connected to the other terminal of the first capacitor, one terminal of the second capacitor, and the second electrode of the driving transistor, respectively,
wherein the voltage corresponding to the image signal is charged in the second capacitor through the switching transistor when the first setting transistor and the second setting transistor are in a turn off state.

6. A method for compensating for a luminance difference of an organic light-emitting display device including a plurality of pixel circuits which are disposed at areas in which a plurality of gate lines supplying scanning signals and a plurality of data lines supplying image signals intersect each other, wherein each of the plurality of pixel circuits comprises: a light-emitting device; a driving transistor configured to control a current flowing in the light emitting device depending on an image signal applied through the data line; a switching transistor connected between a gate electrode of the driving transistor and the data line, and configured to control a conduction state depending on the scanning signal; and first and second capacitors, the method comprising:
charging the first capacitor with a threshold voltage of the driving transistor;
charging the second capacitor with a voltage corresponding to the image signal; and
applying a current corresponding to a summed voltage of a voltage charged in the first capacitor and a voltage charged in the second capacitor to the light-emitting device.

7. The method of claim 6, wherein the threshold voltage of the driving transistor is a voltage between the gate electrode and the second electrode of the driving transistor in a state in which the light-emitting device and the switching transistor are in a turn off state.

8. The method of claim 6, wherein the voltage corresponding to the image signal is charged in the second capacitor through the switching transistor in a state in which the light-emitting device is in a turn off state.

9. An apparatus for compensating for a luminance difference of an organic light-emitting display device including a plurality of pixel circuits which are disposed at areas in which a plurality of gate lines supplying scanning signals and a plurality of data lines supplying image signals intersect each other,
wherein each of the plurality of pixel circuits comprises:
a light-emitting device;
a driving transistor configured to control a current flowing in the light emitting device depending on an image signal applied through the data line;
a switching transistor connected between a gate electrode of the driving transistor and the data line, and configured to control a conduction state depending on the scanning signal;
a third capacitor being charged with a threshold voltage of the driving transistor;
a fourth capacitor being charged with a summed voltage of a voltage corresponding to the image signal and a threshold voltage of the driving transistor charged in the third capacitor, and
the driving transistor applies a current corresponding to the voltage charged in the fourth capacitor to the light-emitting device.

10. The apparatus of claim 9, further comprising:
a transistor disposed between a first voltage source supplying a driving voltage to the light-emitting device and the driving transistor, and configured to switch a current path through which a current flows in the driving transistor,
wherein the third capacitor is charged with a voltage between the gate electrode and a second electrode of the driving transistor as a threshold voltage of the driving transistor in a state in which the switching transistor and the light-emitting control transistor are turned off.

11. The apparatus of claim 9, further comprising:
a transistor disposed between the first voltage source supplying a driving voltage to the light-emitting device and the driving transistor, and configured to switch a current path through which a current flows in the driving transistor,
wherein the fourth transistor is charged with a summed voltage of the voltage corresponding to the image signal applied through the switching transistor and the threshold voltage of the driving transistor charged in the third capacitor in a state in which the light-emitting control transistor is turned off.

12. The apparatus of claim 10, further comprising:
a third setting transistor of which a first electrode is connected to the gate electrode of the driving transistor, the other terminal of the third capacitor, and one terminal of the fourth transistor, and a second electrode is connected to a first electrode of the driving transistor;
a fourth setting transistor of which a first electrode is connected to a second electrode of the switching transistor and one terminal of the third transistor, and a second electrode is connected to a second voltage source; and
a fifth setting transistor of which a first electrode is connected to an anode electrode of the light-emitting device and the second electrode of the driving transistor, and a second electrode is connected to a cathode electrode of the light-emitting device and the second voltage source,
wherein the threshold voltage of the driving transistor is a voltage between the gate electrode and the second electrode of the driving transistor when the third setting transistor, the fourth setting transistor, and the fifth setting transistor are in a conduction state.

13. The apparatus of claim 11, further comprising:
a third setting transistor of which a first electrode is connected to the gate electrode of the driving transistor, the other terminal of the third capacitor, and one terminal of the fourth transistor, and a second electrode is connected to the first electrode of the driving transistor;
a fourth setting transistor of which a first electrode is connected to the second electrode of the switching transistor and one terminal of the third transistor, and a second electrode is connected to the second voltage source; and
a fifth setting transistor of which a first electrode is connected to the anode electrode of the light-emitting device and the second electrode of the driving transistor, and a second electrode is connected to the cathode electrode of the light-emitting device and the second voltage source,
wherein the voltage corresponding to the image signal is charged in the fourth capacitor through the switching transistor when the third setting transistor and the fourth transistor are in a turn off state.

14. A method for compensating for a luminance difference of an organic light-emitting display device including a plurality of pixel circuits which are disposed at areas in which a plurality of gate lines supplying scanning signals and a plurality of data lines supplying image signals intersect each other, wherein each of the plurality of pixel circuits includes a light-emitting device; a driving transistor configured to control a current flowing in the light emitting device depending on an image signal applied through the data line; a switching transistor connected between a gate electrode of the driving transistor and the data line, and configured to control a conduction state depending on the scanning signal; and third and fourth capacitors, the method comprising:
charging the third capacitor with a threshold voltage of the driving transistor;
charging the fourth capacitor with a summed voltage of a voltage corresponding to the image signal and a threshold voltage of the driving transistor charged in the third capacitor, and
applying a current corresponding to a voltage charged in the fourth capacitor to the light-emitting device.

15. The method of claim 14, wherein the threshold voltage of the driving transistor is a voltage between the gate electrode and a second electrode of the driving transistor in a state in which the light-emitting device and the switching transistor are in a turn off state.
